(19) United States
(12) Patent Application Publication
(10) Pub. No.: US 2025/0110607 A1
(43) Pub. Date: Apr. 3, 2025

(54) DISPLAYING VIRTUAL PRESENTATIONS FOR A THEATER APPLICATION

(71) Applicant: Apple Inc., Cupertino, CA (US)

(72) Inventors: Jordan A. CAZAMIAS, San Francisco, CA (US); Jonathan PERRON, Felton, CA (US)

(21) Appl. No.: 18/893,736

(22) Filed: Sep. 23, 2024

Related U.S. Application Data
(60) Provisional application No. 63/586,699, filed on Sep. 29, 2023.

(51) Int. Cl. G06F 3/04815

(52) U.S. Cl. CPC G06F 3/04815

(57) ABSTRACT

Some examples of the disclosure are directed to systems and methods for displaying virtual presentations associated with a theater application in an augmented or fully-immersive three-dimensional environment. In one or more examples of the disclosure, the systems and methods include receiving a request to join a virtual presentation, and in response to receiving the request to join the virtual presentation, displaying a virtual presentation in a three-dimensional environment. The theater presentation is displayed in a manner that facilitates efficient communication between one or more presenter and one or more audience members who are part of the virtual presentation.

### CROSS-REFERENCE TO RELATED APPLICATIONS

This application claims the benefit of U.S. Provisional Application No. 63/586,699, filed Sep. 29, 2023, the content of which is herein incorporated by reference in its entirety for all purposes.

### FIELD OF THE DISCLOSURE

This relates generally to presentations for a theater application displayed in a three-dimensional environment.

### BACKGROUND OF THE DISCLOSURE

Some electronic devices include an application to facilitate a theater presentation session between a presenter and one or more audience members, each using their own separate device.

### SUMMARY OF THE DISCLOSURE

Some examples of the disclosure are directed to systems and methods for displaying virtual presentations associated with a theater application in an augmented or fully-immersive three-dimensional environment. In one or more examples of the disclosure, the systems and methods include receiving a request to join a virtual presentation, and in response to receiving the request to join the virtual presentation, displaying a virtual presentation in a three-dimensional environment. The theater presentation is displayed in a manner that facilitates efficient communication between one or more presenter and one or more audience members who are part of the virtual presentation. According to some examples, the virtual presentation is displayed to each audience member in an audience viewpoint that assumes the user of the electronic device is an audience member of the presentation, optionally with each respective audience member able to view the virtual presentation from the same perspective (e.g., front and center in front of a presentation stage).

In some examples, one or more additional audience members are displayed to one or more the sides of the viewpoint of the user. The representations of one or more additional audience members are optionally based on real-world users who are also viewing the virtual presentation on their own separate devices. For example, the size of the audience represented in the virtual presentation correlates in some way to the number of audience members who join the virtual presentation. In some examples, one or more audience members can be engaged in a direct communication session with the user of the electronic device prior to joining the virtual presentation. For example, three-dimensional environments are presented by multiple devices communicating in a multi-user communication session, optionally with a representation (e.g., avatar) of each user participating in the multi-user communication session displayed in the three-dimensional environment of the multi-user communication session. In some examples, users engaged in a direct communication session with the user of the electronic device can be displayed by the electronic device differently than other audience members not engaged in a direct communication session with the user of the electronic device. For example, those participants in a direct communication session with the user are optionally displayed closer to and at a higher level of detail than other audience members who, while viewing the same virtual presentation as the user of the electronic device on their own devices, are not engaged in a direct communication session with the user of the electronic device prior to joining the virtual presentation. In some examples, the level of detail that each audience member is displayed with, can be based on their distance and/or proximity to the user of the electronic device within the three-dimensional environment. In some examples, the users engaged in a direct communication session are represented as avatars with features unique to the users, whereas other audience members not engaged in a direct communication session are represented as one or more generic-type avatars (e.g., without features unique to those users, or with fewer features unique to those users).

In some examples, the virtual presentation includes an audience reaction user interface that is configured to receive reactions from the user of the device to the virtual presentation (e.g., via inputs to the reaction user interface or via gestures or audio, etc.). The virtual presentation optionally displays the aggregate reactions to the virtual presentation from other audience members (e.g., optionally using the audience reaction user interface). In one or more examples, the electronic device can play audio that mimics the real-world sound that an audience would be making based on the aggregate reactions received by the electronic device. In some examples, the user of the electronic device can indicate their reactions by selecting one or more reaction selection buttons on the audience reaction user interface (e.g., pre-defined reaction selection buttons). Additionally or alternatively, the user can register a reaction by moving one or more portions of their body (e.g., clapping, raising a hand, waving a hand, etc.), that the electronic device can detect and recognize as corresponding to one of the one or more audience reactions.

In some examples, one or more audience members can be promoted to a role different than a generic audience member. In one or more examples, an audience member can be promoted to a presenter by a presenter or other administrator of the virtual presentation. In one or more examples, in response to receiving an indication that the user of electronic device has been promoted to a presenter in the virtual presentation, the electronic device modifies the viewpoint of the user to a presenter viewpoint. In one or more examples, in response to receiving an indication that another audience member different from the user of electronic device has been promoted to a presenter in the virtual presentation, the electronic device updates the virtual presentation to display the promoted audience member as a presenter (e.g., including an avatar representation with unique details for the promoted audience member). In some examples, an audience member can be promoted to a questioner. In response to receiving an indication that that the user of the electronic device has been promoted to a presenter, the electronic device displays the virtual presentation from a questioner viewpoint. In some examples, in response to receiving an indication that another audience member different from the user of electronic device has been promoted to a questioner in the virtual presentation, the electronic device updates the virtual presentation to display the promoted audience member as a questioner (e.g., optionally in a predetermined location, such as close to the stage, but off-center, optionally including an avatar representation with unique details for the promoted audience member), and optionally including a representation of a microphone or lectern or other virtual objects).

### BRIEF DESCRIPTION OF THE DRAWINGS

For improved understanding of the various examples described herein, reference should be made to the Detailed Description below along with the following drawings. Like reference numerals often refer to corresponding parts throughout the drawings.

FIG. 1 illustrates an electronic device presenting an extended reality environment according to some examples of the disclosure.

FIG. 2 illustrates a block diagram of an example architecture for a device according to some examples of the disclosure.

FIGS. 3A-M illustrate example virtual presentation environments associated with a theater application according to examples of the disclosure.

FIG. 4 illustrates an example flow diagram illustrating a method of displaying virtual presentations associated with a theater application according to examples of the disclosure.

### DETAILED DESCRIPTION

Some examples of the disclosure are directed to systems and methods for displaying virtual presentations associated with a theater application in an augmented or fully-immersive three-dimensional environment. In one or more examples of the disclosure, the systems and methods include receiving a request to join a virtual presentation, and in response to receiving the request to join the virtual presentation, displaying a virtual presentation in a three-dimensional environment. The theater presentation is displayed in a manner that facilitates efficient communication between one or more presenter and one or more audience members who are part of the virtual presentation. According to some examples, the virtual presentation is displayed to each audience member in an audience viewpoint that assumes the user of the electronic device is an audience member of the presentation, optionally with each respective audience member able to view the virtual presentation from the same perspective (e.g., front and center in front of a presentation stage).

In some examples, one or more additional audience members are displayed to one or more the sides of the viewpoint of the user. The representations of one or more additional audience members are optionally based on real-world users who are also viewing the virtual presentation on their own separate devices. For example, the size of the audience represented in the virtual presentation correlates in some way to the number of audience members who join the virtual presentation. In some examples, one or more audience members can be engaged in a direct communication session with the user of the electronic device prior to joining the virtual presentation. For example, three-dimensional environments are presented by multiple devices communicating in a multi-user communication session, optionally with a representation (e.g., avatar) of each user participating in the multi-user communication session displayed in the three-dimensional environment of the multi-user communication session. In some examples, users engaged in a direct communication session with the user of the electronic device can be displayed by the electronic device differently than other audience members not engaged in a direct communication session with the user of the electronic device. For example, those participants in a direct communication session with the user are optionally displayed closer to and at a higher level of detail than other audience members who, while viewing the same virtual presentation as the user of the electronic device on their own devices, are not engaged in a direct communication session with the user of the electronic device prior to joining the virtual presentation. In some examples, the level of detail that each audience member is displayed with, can be based on their distance and/or proximity to the user of the electronic device within the three-dimensional environment. In some examples, the users engaged in a direct communication session are represented as avatars with features unique to the users, whereas other audience members not engaged in a direct communication session are represented as one or more generic-type avatars (e.g., without features unique to those users, or with fewer features unique to those users).

In some examples, the virtual presentation includes an audience reaction user interface that is configured to receive reactions from the user of the device to the virtual presentation (e.g., via inputs to the reaction user interface or via gestures or audio, etc.). The virtual presentation optionally displays the aggregate reactions to the virtual presentation from other audience members (e.g., optionally using the audience reaction user interface). In one or more examples, the electronic device can play audio that mimics the real-world sound that an audience would be making based on the aggregate reactions received by the electronic device. In some examples, the user of the electronic device can indicate their reactions by selecting one or more reaction selection buttons on the audience reaction user interface (e.g., pre-defined reaction selection buttons). Additionally or alternatively, the user can register a reaction by moving one or more portions of their body (e.g., clapping, raising a hand, waving a hand, etc.), that the electronic device can detect and recognize as corresponding to one of the one or more audience reactions.

In some examples, one or more audience members can be promoted to a role different than a generic audience member. In one or more examples, an audience member can be promoted to a presenter by a presenter or other administrator of the virtual presentation. In one or more examples, in response to receiving an indication that the user of the electronic device has been promoted to a presenter in the virtual presentation, the electronic device modifies the viewpoint of the user to a presenter viewpoint. In one or more examples, in response to receiving an indication that another audience member different from the user of the electronic device has been promoted to a presenter in the virtual presentation, the electronic device updates the virtual presentation to display the promoted audience member as a presenter (e.g., including an avatar representation with unique details for the promoted audience member). In some examples, an audience member can be promoted to a questioner. In response to receiving an indication that that the user of the electronic device has been promoted to a presenter, the electronic device displays the virtual presentation from a questioner viewpoint. In some examples, in response to receiving an indication that another audience member different from the user of electronic device has been promoted to a questioner in the virtual presentation, the electronic device updates the virtual presentation to display the promoted audience member as a questioner (e.g., optionally in a predetermined location, such as close to the stage, but off-center, optionally including an avatar representation with unique details for the promoted audience member), and optionally including a representation of a microphone or lectern or other virtual objects).

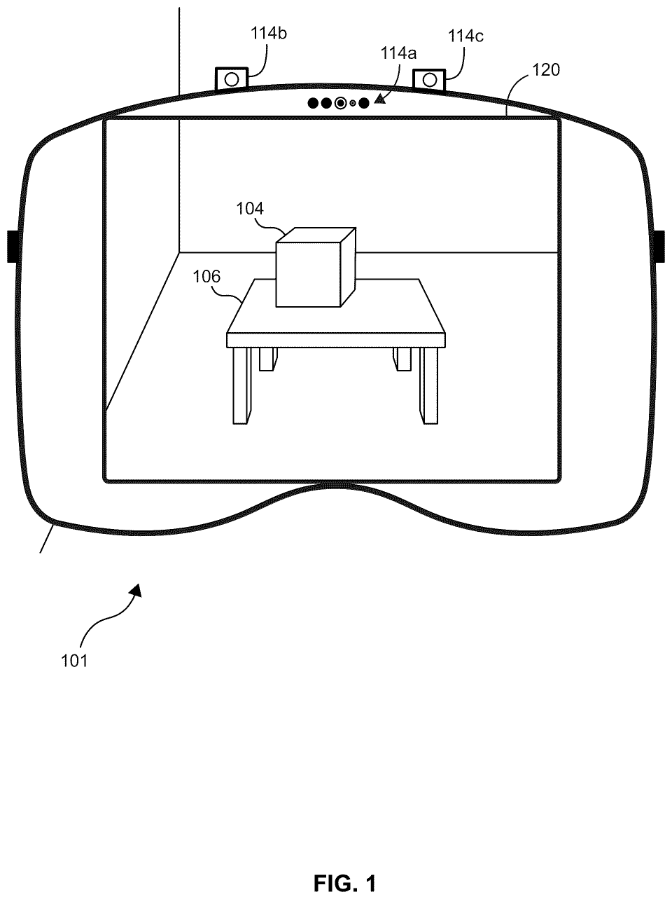

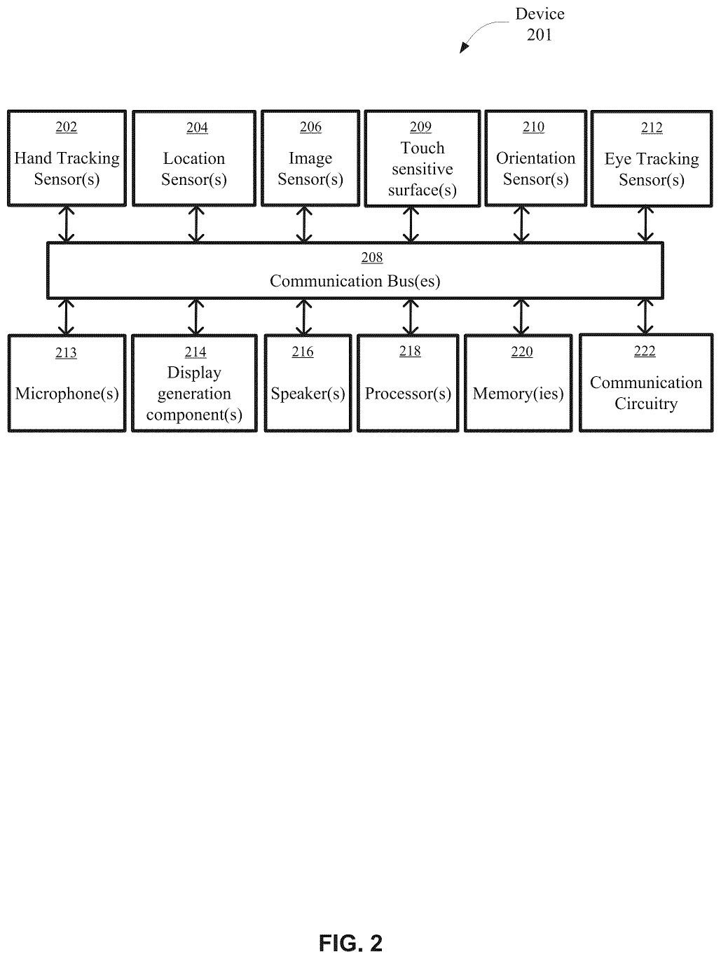

FIG. 1 illustrates an electronic device 101 presenting an extended reality (XR) environment (e.g., a computer-generated environment optionally including representations of physical and/or virtual objects) according to some examples of the disclosure. In some examples, as shown in FIG. 1, electronic device 101 is a head-mounted display or other head-mountable device configured to be worn on a head of a user of the electronic device 101. Examples of electronic device 101 are described below with reference to the architecture block diagram of FIG. 2. As shown in FIG. 1, electronic device 101 and table 106 are located in a physical environment. The physical environment may include physical features such as a physical surface (e.g., floor, walls) or a physical object (e.g., table, lamp, etc.). In some examples, electronic device 101 may be configured to detect and/or capture images of physical environment including table 106 (illustrated in the field of view of electronic device 101).

In some examples, as shown in FIG. 1, electronic device 101 includes one or more internal image sensors 114a oriented towards a face of the user (e.g., eye tracking cameras described below with reference to FIG. 2). In some examples, internal image sensors 114a are used for eye tracking (e.g., detecting a gaze of the user). Internal image sensors 114a are optionally arranged on the left and right portions of display 120 to enable eye tracking of the user's left and right eyes. In some examples, electronic device 101 also includes external image sensors 114b and 114c facing outwards from the user to detect and/or capture the physical environment of the electronic device 101 and/or movements of the user's hands or other body parts.

In some examples, display 120 has a field of view visible to the user (e.g., that may or may not correspond to a field of view of external image sensors 114b and 114c). Because display 120 is optionally part of a head-mounted device, the field of view of display 120 is optionally the same as or similar to the field of view of the user's eyes. In other examples, the field of view of display 120 may be smaller than the field of view of the user's eyes. In some examples, electronic device 101 may be an optical see-through device in which display 120 is a transparent or translucent display through which portions of the physical environment may be directly viewed. In some examples, display 120 may be included within a transparent lens and may overlap all or only a portion of the transparent lens. In other examples, electronic device may be a video-passthrough device in which display 120 is an opaque display configured to display images of the physical environment captured by external image sensors 114b and 114c.

In some examples, in response to a trigger, the electronic device 101 may be configured to display a virtual object 104 in the XR environment represented by a cube illustrated in FIG. 1, which is not present in the physical environment, but is displayed in the XR environment positioned on the top of real-world table 106 (or a representation thereof). Optionally, virtual object 104 can be displayed on the surface of the table 106 in the XR environment displayed via the display 120 of the electronic device 101 in response to detecting the planar surface of table 106 in the physical environment 100.

It should be understood that virtual object 104 is a representative virtual object and one or more different virtual objects (e.g., of various dimensionality such as two-dimensional or other three-dimensional virtual objects) can be included and rendered in a three-dimensional XR environment. For example, the virtual object can represent an application or a user interface displayed in the XR environment. In some examples, the virtual object can represent content corresponding to the application and/or displayed via the user interface in the XR environment. In some examples, the virtual object 104 is optionally configured to be interactive and responsive to user input (e.g., air gestures, such as air pinch gestures, air tap gestures, and/or air touch gestures), such that a user may virtually touch, tap, move, rotate, or otherwise interact with, the virtual object 104.

In some examples, displaying an object in a three-dimensional environment may include interaction with one or more user interface objects in the three-dimensional environment. For example, initiation of display of the object in the three-dimensional environment can include interaction with one or more virtual options/affordances displayed in the three-dimensional environment. In some examples, a user's gaze may be tracked by the electronic device as an input for identifying one or more virtual options/affordances targeted for selection when initiating display of an object in the three-dimensional environment. For example, gaze can be used to identify one or more virtual options/affordances targeted for selection using another selection input. In some examples, a virtual option/affordance may be selected using hand-tracking input detected via an input device in communication with the electronic device. In some examples, objects displayed in the three-dimensional environment may be moved and/or reoriented in the three-dimensional environment in accordance with movement input detected via the input device.

In the discussion that follows, an electronic device that is in communication with a display generation component and one or more input devices is described. It should be understood that the electronic device optionally is in communication with one or more other physical user-interface devices, such as a touch-sensitive surface, a physical keyboard, a mouse, a joystick, a hand tracking device, an eye tracking device, a stylus, etc. Further, as described above, it should be understood that the described electronic device, display and touch-sensitive surface are optionally distributed amongst two or more devices. Therefore, as used in this disclosure, information displayed on the electronic device or by the electronic device is optionally used to describe information outputted by the electronic device for display on a separate display device (touch-sensitive or not). Similarly, as used in this disclosure, input received on the electronic device (e.g., touch input received on a touch-sensitive surface of the electronic device, or touch input received on the surface of a stylus) is optionally used to describe input received on a separate input device, from which the electronic device receives input information.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, a television channel browsing application, and/or a digital video player application.

FIG. 2 illustrates a block diagram of an example architecture for an electronic device 201 according to some examples of the disclosure. In some examples, electronic device 201 includes one or more electronic devices. For example, the electronic device 201 may be a portable computing device, an auxiliary device in communication with another device, a head-mounted display, etc., respectively. In some examples, electronic device 201 corresponds to electronic device 101 described above with reference to FIG. 1.

As illustrated in FIG. 2, the electronic device 201 optionally includes various sensors, such as one or more hand tracking sensors 202, one or more location sensors 204, one or more image sensors 206 (optionally corresponding to internal image sensors 114a and/or external image sensors 114b and 114c in FIG. 1), one or more touch-sensitive surfaces 209, one or more motion and/or orientation sensors 210, one or more eye tracking sensors 212, one or more microphones 213 or other audio sensors, one or more body tracking sensors (e.g., torso and/or head tracking sensors), one or more display generation components 214, optionally corresponding to display 120 in FIG. 1, one or more speakers 216, one or more processors 218, one or more memories 220, and/or communication circuitry 222. One or more communication buses 208 are optionally used for communication between the above-mentioned components of electronic devices 201.

Communication circuitry 222 optionally includes circuitry for communicating with electronic devices, networks, such as the Internet, intranets, a wired network and/or a wireless network, cellular networks, and wireless local area networks (LANs). Communication circuitry 222 optionally includes circuitry for communicating using near-field communication (NFC) and/or short-range communication, such as Bluetooth®.

Processor(s) 218 include one or more general processors, one or more graphics processors, and/or one or more digital signal processors. In some examples, memory 220 is a non-transitory computer-readable storage medium (e.g., flash memory, random access memory, or other volatile or non-volatile memory or storage) that stores computer-readable instructions configured to be executed by processor(s) 218 to perform the techniques, processes, and/or methods described below. In some examples, memory 220 can include more than one non-transitory computer-readable storage medium. A non-transitory computer-readable storage medium can be any medium (e.g., excluding a signal) that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on compact disc (CD), digital versatile disc (DVD), or Blu-ray technologies, as well as persistent solid-state memory such as flash, solid-state drives, and the like.

In some examples, display generation component(s) 214 include a single display (e.g., a liquid-crystal display (LCD), organic light-emitting diode (OLED), or other types of display). In some examples, display generation component(s) 214 includes multiple displays. In some examples, display generation component(s) 214 can include a display with touch capability (e.g., a touch screen), a projector, a holographic projector, a retinal projector, a transparent or translucent display, etc. In some examples, electronic device 201 includes touch-sensitive surface(s) 209, respectively, for receiving user inputs, such as tap inputs and swipe inputs or other gestures. In some examples, display generation component(s) 214 and touch-sensitive surface(s) 209 form touch-sensitive display(s) (e.g., a touch screen integrated with electronic device 201 or external to electronic device 201 that is in communication with electronic device 201).

Electronic device 201 optionally includes image sensor(s) 206. Image sensors(s) 206 optionally include one or more visible light image sensors, such as charged coupled device (CCD) sensors, and/or complementary metal-oxide-semiconductor (CMOS) sensors operable to obtain images of physical objects from the real-world environment. Image sensor(s) 206 also optionally include one or more infrared (IR) sensors, such as a passive or an active IR sensor, for detecting infrared light from the real-world environment. For example, an active IR sensor includes an IR emitter for emitting infrared light into the real-world environment. Image sensor(s) 206 also optionally include one or more cameras configured to capture movement of physical objects in the real-world environment. Image sensor(s) 206 also optionally include one or more depth sensors configured to detect the distance of physical objects from electronic device 201. In some examples, information from one or more depth sensors can allow the device to identify and differentiate objects in the real-world environment from other objects in the real-world environment. In some examples, one or more depth sensors can allow the device to determine the texture and/or topography of objects in the real-world environment.

In some examples, electronic device 201 uses CCD sensors, event cameras, and depth sensors in combination to detect the physical environment around electronic device 201. In some examples, image sensor(s) 206 include a first image sensor and a second image sensor. The first image sensor and the second image sensor work in tandem and are optionally configured to capture different information of physical objects in the real-world environment. In some examples, the first image sensor is a visible light image sensor and the second image sensor is a depth sensor. In some examples, electronic device 201 uses image sensor(s) 206 to detect the position and orientation of electronic device 201 and/or display generation component(s) 214 in the real-world environment. For example, electronic device 201 uses image sensor(s) 206 to track the position and orientation of display generation component(s) 214 relative to one or more fixed objects in the real-world environment.

In some examples, electronic device 201 includes microphone(s) 213 or other audio sensors. Electronic device 201 optionally uses microphone(s) 213 to detect sound from the user and/or the real-world environment of the user. In some examples, microphone(s) 213 includes an array of microphones (a plurality of microphones) that optionally operate in tandem, such as to identify ambient noise or to locate the source of sound in space of the real-world environment.

Electronic device 201 includes location sensor(s) 204 for detecting a location of electronic device 201 and/or display generation component(s) 214. For example, location sensor(s) 204 can include a global positioning system (GPS) receiver that receives data from one or more satellites and allows electronic device 201 to determine the device's absolute position in the physical world.

Electronic device 201 includes orientation sensor(s) 210 for detecting orientation and/or movement of electronic device 201 and/or display generation component(s) 214. For example, electronic device 201 uses orientation sensor(s) 210 to track changes in the position and/or orientation of electronic device 201 and/or display generation component(s) 214, such as with respect to physical objects in the real-world environment. Orientation sensor(s) 210 optionally include one or more gyroscopes and/or one or more accelerometers.

Electronic device 201 includes hand tracking sensor(s) 202 and/or eye tracking sensor(s) 212 (and/or other body tracking sensor(s), such as leg, torso and/or head tracking sensor(s)), in some examples. Hand tracking sensor(s) 202 are configured to track the position/location of one or more portions of the user's hands, and/or motions of one or more portions of the user's hands with respect to the extended reality environment, relative to the display generation component(s) 214, and/or relative to another defined coordinate system. Eye tracking sensor(s) 212 are configured to track the position and movement of a user's gaze (eyes, face, or head, more generally) with respect to the real-world or extended reality environment and/or relative to the display generation component(s) 214. In some examples, hand tracking sensor(s) 202 and/or eye tracking sensor(s) 212 are implemented together with the display generation component(s) 214. In some examples, the hand tracking sensor(s) 202 and/or eye tracking sensor(s) 212 are implemented separate from the display generation component(s) 214.

In some examples, the hand tracking sensor(s) 202 (and/or other body tracking sensor(s), such as leg, torso and/or head tracking sensor(s)) can use image sensor(s) 206 (e.g., one or more IR cameras, three-dimensional (3D) cameras, depth cameras, etc.) that capture three-dimensional information from the real-world including one or more body parts (e.g., hands, legs, torso, or head of a human user). In some examples, the hands can be resolved with sufficient resolution to distinguish fingers and their respective positions. In some examples, one or more image sensors 206 are positioned relative to the user to define a field of view of the image sensor(s) 206 and an interaction space in which finger/hand position, orientation and/or movement captured by the image sensors are used as inputs (e.g., to distinguish from a user's resting hand or other hands of other persons in the real-world environment). Tracking the fingers/hands for input (e.g., gestures, touch, tap, etc.) can be advantageous in that it does not require the user to touch, hold or wear any sort of beacon, sensor, or other marker.

In some examples, eye tracking sensor(s) 212 includes at least one eye tracking camera (e.g., infrared (IR) cameras) and/or illumination sources (e.g., IR light sources, such as LEDs) that emit light towards a user's eyes. The eye tracking cameras may be pointed towards a user's eyes to receive reflected IR light from the light sources directly or indirectly from the eyes. In some examples, both eyes are tracked separately by respective eye tracking cameras and illumination sources, and a focus/gaze can be determined from tracking both eyes. In some examples, one eye (e.g., a dominant eye) is tracked by one or more respective eye tracking cameras/illumination sources.

Electronic device 201 is not limited to the components and configuration of FIG. 2, but can include fewer, other, or additional components in multiple configurations. In some examples, electronic device 201 can be implemented between two electronic devices (e.g., as a system). In some such examples, each of (or more) electronic device may each include one or more of the same components discussed above, such as various sensors, one or more display generation components, one or more speakers, one or more processors, one or more memories, and/or communication circuitry. A person or persons using electronic device 201, is optionally referred to herein as a user or users of the device.

Attention is now directed towards a virtual presentation and interactions with one or more virtual objects that are displayed in a three-dimensional environment presented at an electronic device (e.g., corresponding to electronic device 201), and specifically, interactions with the virtual presentation displayed in a three-dimensional environment and associated with a theater application.

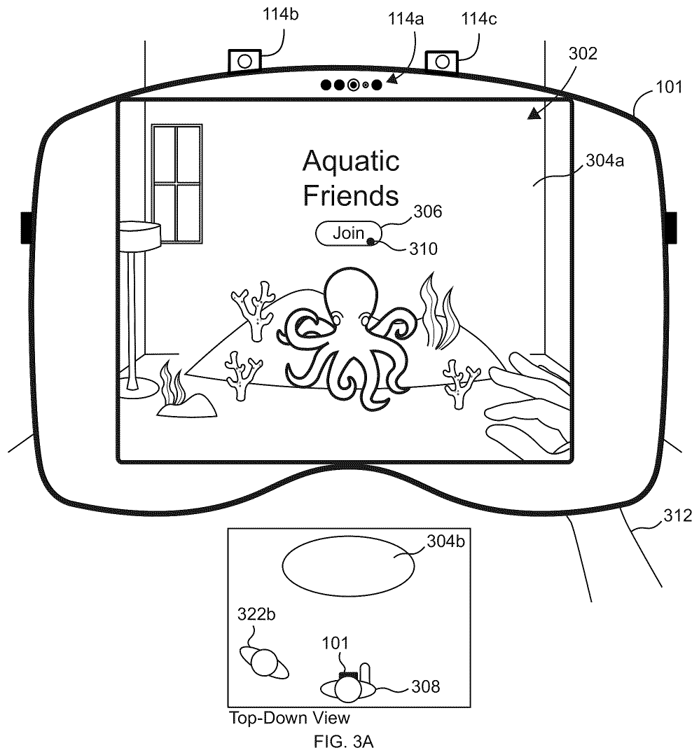

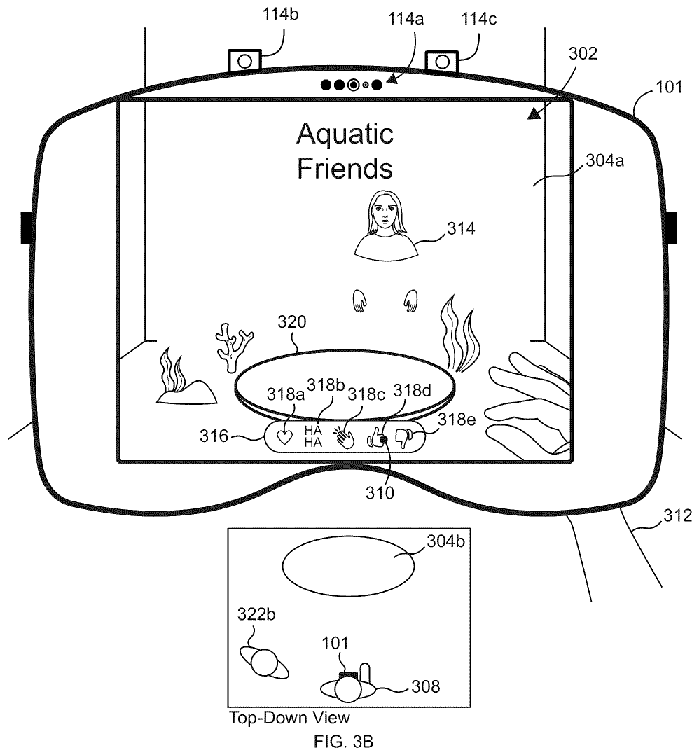

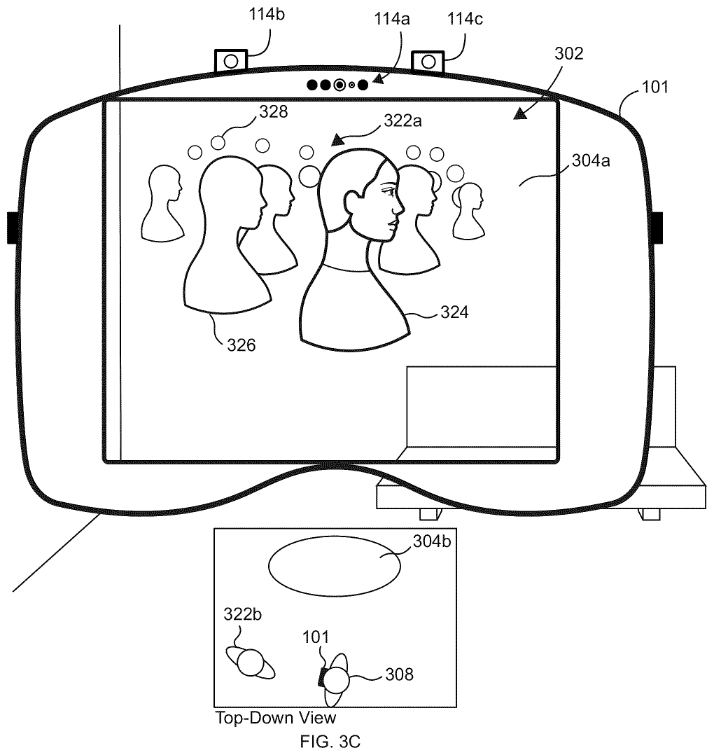

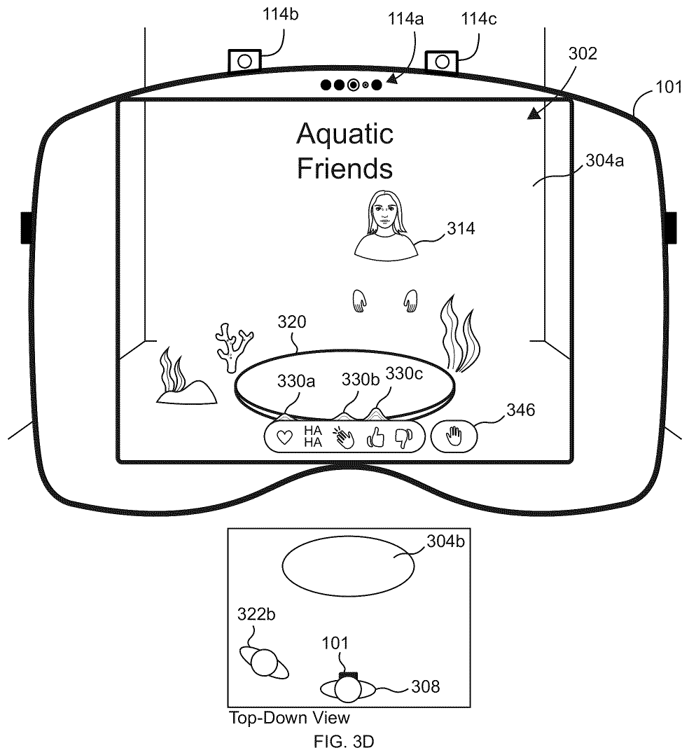

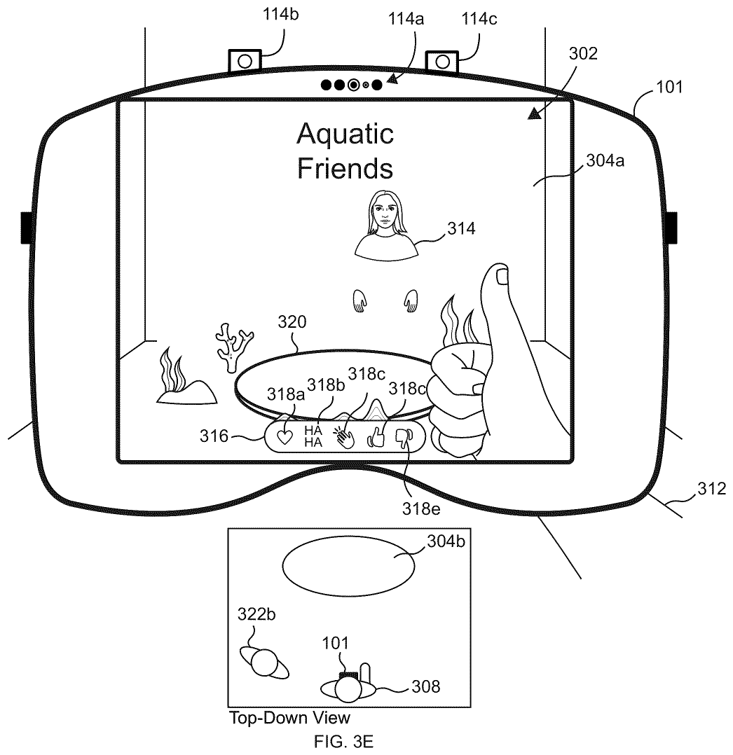

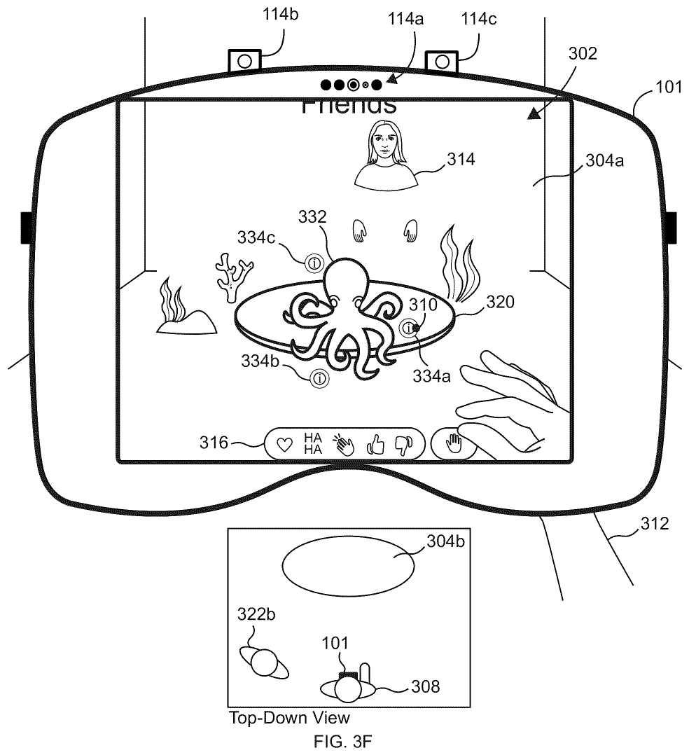

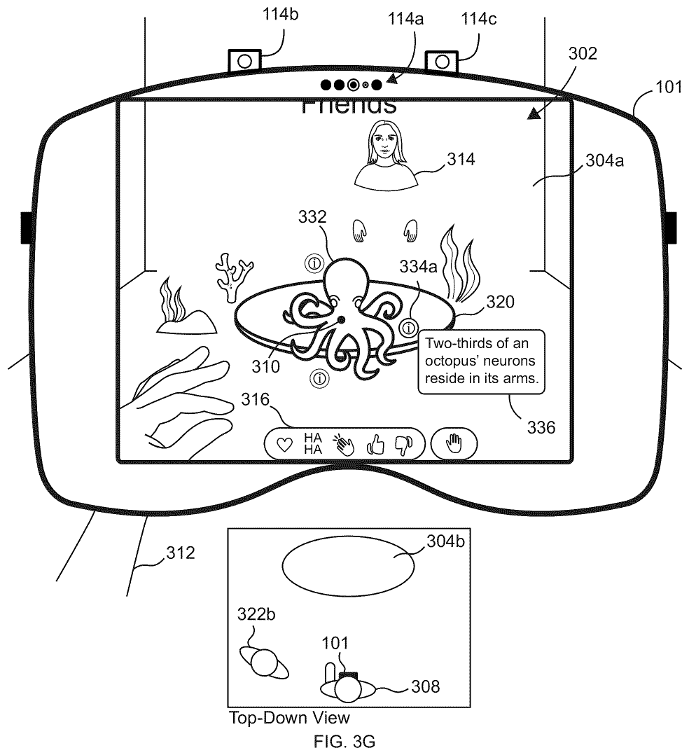

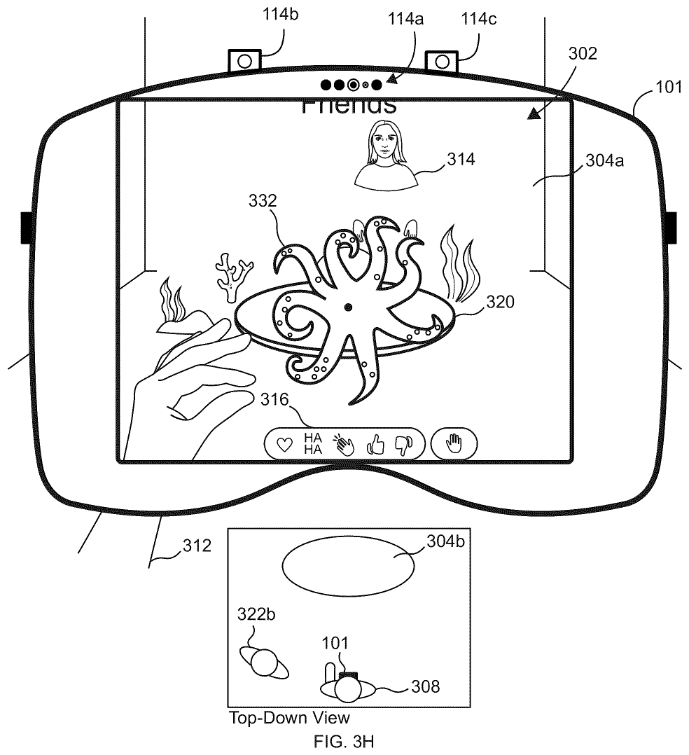

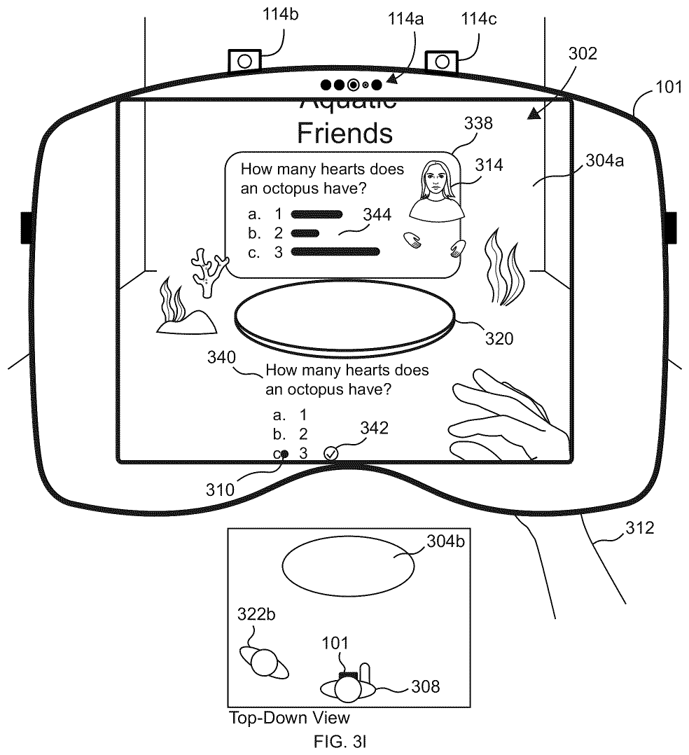

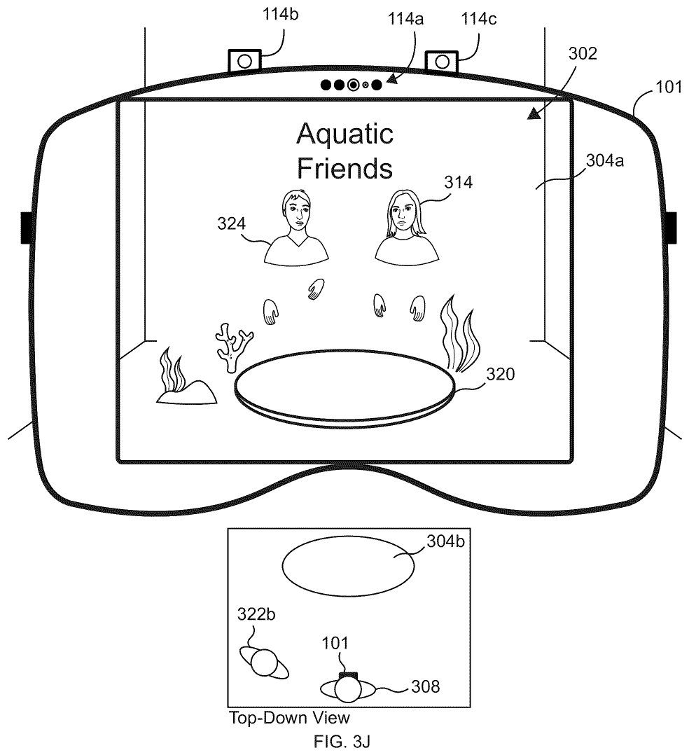

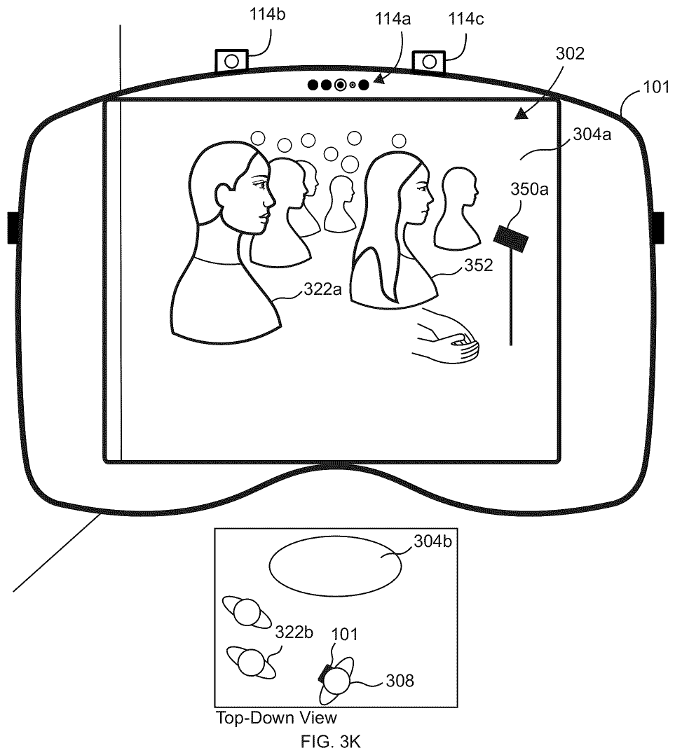

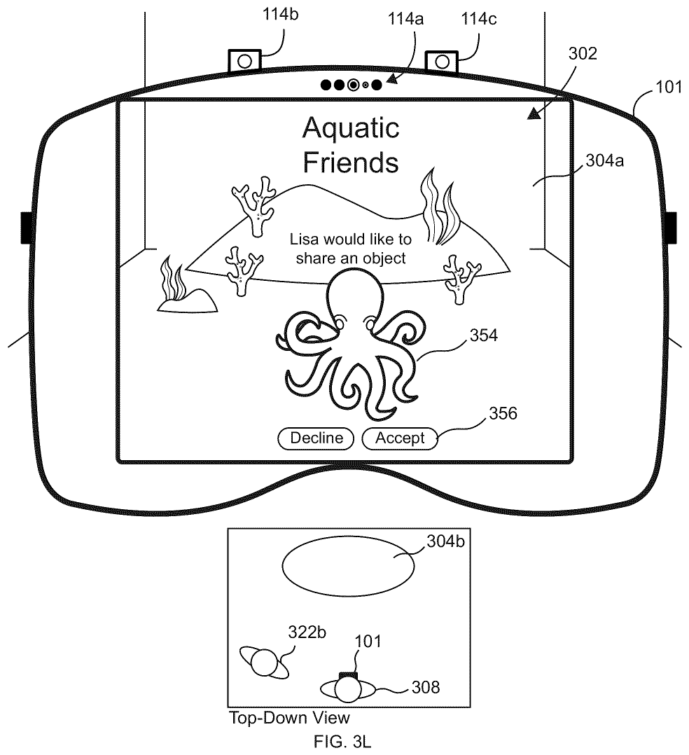

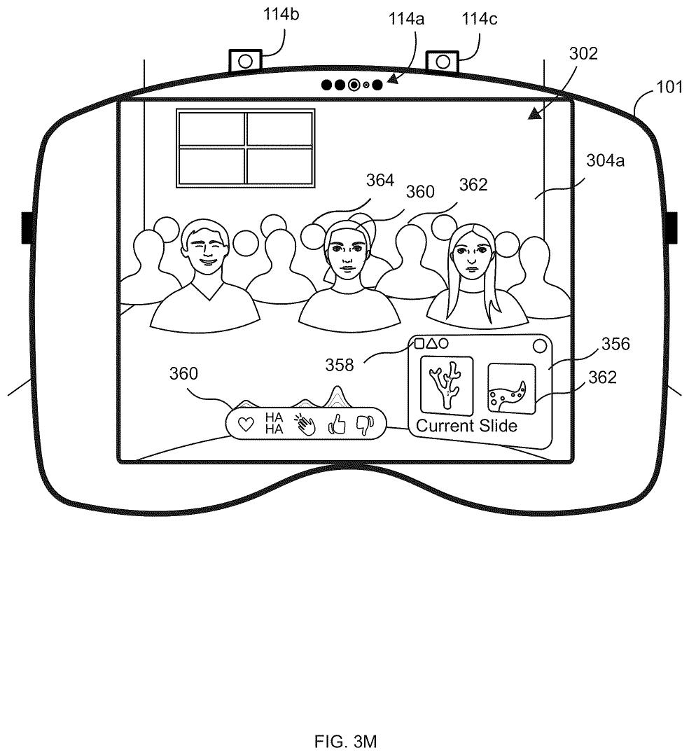

FIGS. 3A-3M illustrate example virtual presentation environments associated with a theater application according to examples of the disclosure. FIG. 3A illustrates an example virtual presentation 304a (illustrated in the top-down view as 304b) that is displayed by electronic device 101 within a three-dimensional environment 302. In one or more examples, the virtual presentation 304a includes an introduction view as illustrated in FIG. 3A displayed prior to joining and/or a start of a virtual presentation. The introduction view is optionally displayed in an XR environment in which portions of the real-world environment are visible on the periphery of the user of the electronic device and the periphery of the introduction view. For example, FIG. 3A shows walls, a lamp, and a window at the periphery of the introduction view of the virtual presentation. The introduction view optionally provides a title of the presentation (e.g., “Aquatic Friends”) and one or more images or virtual objects associated with the presentation, so as to convey to the user of the computer device the topic and/or subject matter of the virtual presentation. In one or more examples, the virtual objects include objects associated with the virtual presentation presented within the bounds of introduction view (e.g., within the bounds of virtual presentation 304b) and optionally outside the introductory view, within the real-world environment. For example, FIG. 3A illustrates aquatic related virtual objects such as a rock or seafloor, coral, seaweed, and an octopus within the bounds of the introductory view, but also presents a rock, seaweed, and coral partially on the real-world floor.

In one or more examples, the introduction view illustrated in FIG. 3A as part of virtual presentation 304a includes a launch user interface 306 for accessing the virtual presentation. In one or more examples, the launch user interface 306 is interactable by the user (described in detail below), and optionally selection of a launch affordance (e.g., a join button shown in FIG. 3A) allows the user to be admitted to the virtual presentation and further interact with the virtual presentation (also described in detail below).

In one or more examples, and as illustrated in FIG. 3A, the user can join the virtual presentation 304a by directing their gaze 310 at launch user interface 306 while executing an air gesture (such as an air pinch) using their hand 312, thereby indicating to electronic device 101 the user's desire to join and/or further interact with the virtual presentation. In one or more examples, and in response to receiving a selection of the selectable option of launch user interface 306, electronic device 101 displays the virtual presentation in an audience viewpoint as illustrated in FIG. 3B.

In the example of FIG. 3B, virtual presentation 304a is now displayed by electronic device 101 is an audience viewpoint mode (in response to selection of launch user interface 306). In one or more examples, the audience viewpoint illustrated in FIG. 3B is configured to convey to the user that they are part of the audience of the virtual presentation 304a. For instance, in one or more examples, virtual presentation 304b is displayed in three-dimensional environment 304 in front of the perspective of user 308 as illustrated in the top-down view. In one or more examples, virtual presentation 304a includes a virtual stage 320 upon which, a presenter 314 is displayed. In one or more examples, the virtual stage 320 as well as other features of virtual presentation 304a are overlaid on the three-dimensional environment. For instance, in one or more examples, if the three-dimensional environment is an XR environment wherein the three-dimensional environment includes some real-world elements, then the virtual presentation is overlaid on the real-world environment such that the user will be able to view the virtual presentation while still being able to view some of the physical real-world environment displayed in the three-dimensional environment. In one or more examples, the level of immersion changes when moving from the introduction view of FIG. 3A to the virtual presentation of FIG. 3B. For example, optionally the size of the bounds of the virtual presentation are increased, less of the real-world is visible (e.g., the lamp and window shown in FIG. 3A are no longer visible in FIG. 3B, but the real-world periphery of the user of the computing system may still be visible, such as side views of the real-world environment if the user's head rotates 45-60 degrees), portions of the real-world are more faded, environmental lighting changes to dim real-world lighting and apply lighting associated with the theater application, etc. In some examples, presenter 314 is displayed using an avatar or other three-dimensional representation that can be based on the likeness of a user of an external electronic device associated with the presenter. In one or more examples, the presenter 314, and in particular the representation of presenter 314 displayed in virtual presentation 304a, can move in accordance with movement of the real-world user associated with the presenter 314. For instance, the electronic device 101 can move the hands of presenter 314 in accordance with real-world movement of the user associated with presenter 314's hands. As another example, movement from a first position to a second position in the real world can reposition the presenter to a different location on the stage 320.

Although not shown in FIG. 3B, when joining the presentation prior to the presenter joining or starting the presentation, the virtual presentation optionally shows a modified version of the introduction view without the launch user interface 306 and without showing presenter 314 and stage 320 until the presentation is initiated by the presenter. In one or more examples, the modified version of the introduction view is shown with an increased level of immersion compared with the introduction view of FIG. 3A. In one or more examples, the modified version of the introduction view optionally includes a representation of time until the start of the presentation (e.g., a numerical countdown).

In one or more examples, electronic device 101 can emit audio captured by an electronic device associated with presenter 314. For instance, the electronic device associated with presenter 314, using one or more microphones, can collect audio of presenter 314 and transmit that audio to electronic device 101 (optionally via one or more intermediary electronic devices, such as servers). In response to receiving the audio from presenter 314, electronic device 101 emits audio that the user 308 of electronic device 101 can hear, thereby allowing the user to hear real-time audio from presenter 314.

In one or more examples, electronic device 101 displays virtual presentation 304a with one or more representations of audience members 322a as illustrated in FIG. 3C. In some examples, a subset of the audience members is in a communication session with the user of electronic device 101. For example, audience member 322b shown in the top-down view of FIG. 3B corresponds to a user of another electronic device who is also attending the virtual presentation 304a and was previously engaged in a communication session with the user of electronic device 101. It is understood that although audience member 322b illustrates a single audience member engaged in a communication session with the user of electronic device 101, that multiple audience members are optionally engaged in the communication session with the user of electronic device 101 and can be arranged to the sides of user 308. Audience member 322b is included in the top-down view of FIG. 3B, audience member 322b because audience member has a spatial relationship with user 308 based on the communication session. The arrangement and positioning of additional users such as audience member 322b with respect to user 308 is optionally defined by spatial templates for the communication session with respect to shared content such as the virtual presentation 304b.

In some examples, and as shown in FIG. 3C, the electronic device 101 places the audience members 322b to the side(s) of user 308 within three-dimensional environment 302. Thus, in one or more examples, user 308 can view the other audience member 322b if the user changes their perspective (e.g., rotates the head and/or electronic device 101) within three-dimensional environment 302 such that they are face to their side and towards the location of the audience member 322b as illustrated in FIG. 3C. In the example of FIG. 3C, user 308 has changed their perspective (for instance by turning their head or body to the left) such that they are now facing the audience members 322b as illustrated in the top-down view. In one or more examples, each audience member can be placed in the center front-row seat of the audience, such that each individual audience member will have the same perspective of the presentation.

In one or more examples, the audience members 322a illustrated in FIG. 3C can be displayed with varying levels of detail based one or more factors as discussed below. For instance, in one or more examples, one or more audience members that are engaged in a communication session with user 308 (e.g., communicating with user 308 prior to and outside of the context of the virtual presentation and/or the theater application associated with the virtual presentation) can be represented as an audience member 324 of audience members 322a according to a high-fidelity level (e.g., an avatar with distinctive features). In some examples, the high-fidelity level of detail can include visible features of the audience member's face (e.g., eye color, eye shape, nose, hair, hair color, skin color) that correspond to the real-world likeness of the user associated with audience member 324. In some examples, the high-fidelity level of detail can include movement that is based on the physical movement of the represented user. In some examples, the movement can include facial gestures, movement of portions of the body that are also represented in the avatar representation of the audience member, etc. In some examples, the high-fidelity level of detail may not include translational movement (e.g., walking around a room). In one or more examples, the audience members 322a that are not in a communication session with user 308 are represented as one or more generic-type avatars (e.g., without features unique to those users, or with fewer features unique to those users). In some examples, generic-type avatars may exhibit movement as described above, except that the movement may not be based on the real-world movements of the user that the generic avatar is meant to represent.

In some examples, the level of detail displayed for each audience member of audience members 322a can be based on the audience member's proximity to user 308 within three-dimensional environment 302. For instance, audience member 326 can be displayed according to a medium-fidelity level of detail wherein audience member 326 is shown as a silhouette (e.g., in the shape of a human avatar) without being displayed with any features such as eyes, noise, face, etc. that audience member 324 is displayed with. In some examples, the appearance of audience member 326 may not be based on any real-world image data of the user associated with audience member 326. In some examples, audience members that are further away than audience member 326 such as audience member 328 may be displayed according to a low-fidelity level of detail. For instance, audience member 328 is represented by an abstract shape or outline rather than a silhouette of a human form like audience member 326. In some examples, audience member 328 can be animated to move based on an aggregate response of the users that the audience member 328 is meant to represent. In some examples, the placement of audience members (excluding audience members who are engaged in a communication session with user 308, such as audience member 324 corresponding to audience member 322b) within three-dimensional environment 302 can be randomized or based on one or more criteria such as geographic proximity to the user or other factors.

In some examples, the user 308 can hear audio from the audience members. For instance, if an audience member is clapping or talking during a presentation, the audio can be recorded by the individual devices of the audience members, transmitted to electronic device 101, and replayed to user 308. In some examples, and in order to maintain privacy and/or to avoid overwhelming or distracting user 308 with too much noise, rather than capturing and playing the direct audio from each of the audience members, electronic device 101 can emit mimicked crowd noise (e.g., synthetic crowd noise) at a pre-defined volume such that the user cannot hear the contents of what the audience members are saying and will not be distracted by the noise coming from other audience members, but will understand that the audience is talking. In some examples, electronic device 101, after converting audience noise into a synthetic sound, can set the volume of the audience noise in accordance with the number of audience members that are transmitting sound, and/or the volume of the audio recorded for each audience member.

In some examples, each respective device (e.g., the device of the audience member talking) can generate a synthetic sound and transmit the generated sound to a server that can then transmit the synthetic sound to each electronic device that is associated with the virtual presentation. Additionally or alternatively, each respective device can transmit recorded audio to a server that processes the sound to generate a synthetic sound, and upon processing the sound the server transmits the synthetic audio to each device associated with the virtual presentation. While the example of conversation is used above, the same techniques for processing audience sound can apply to other types of audience audio such as clapping, laughing, booing, etc. In some examples, audio from other audience members maybe selectively transmitted to the user (rather than having a synthetic sound). For instance, in an example, where the audience member is engaged in a direct communication session with the user of electronic device 101, the electronic device can emit the actual audio recorded from the other user's device (rather than a synthetic sound). In one or more examples, the volume of the synthetic sound can be adjusted according to the current state of the virtual presentation. For instance, if presenter 314 is speaking the synthetic sound can be played at a lower volume than if the presenter 314 is not speaking.

Additionally, as described below, the audio is optionally generated based on inputs to an audience reaction user interface by audience members of the virtual presentation. Returning to the example of FIG. 3B, virtual presentation 304a can include an audience reaction user interface 316 for receiving reactions from user 308 to the virtual presentation. The same audience reaction user interface is optionally presented to other audience members using their respective electronic devices. In some examples, and as illustrated in FIG. 3B, audience reaction user interface 316 can be placed in front of (with respect to the perspective of the user) stage 320 such that the interface is within physical reach of the user. Optionally, the audience reaction user interface 316 can be placed in a location within the three-dimensional environment such that it does not impede the user's 308 view of the presenter 314 or other aspects of virtual presentation 304a. In some examples, the audience reaction user interface providing visual indicators of other audience members' reactions (e.g., aggregated from the audience members) to virtual presentation 304a. In some examples, audience reaction user interface 316 includes selectable options 318a-318e, with each selectable option corresponding to a pre-defined reaction. For example, selectable option 318a corresponds to a “heart” or “love” reaction, which when selected by the user conveys that the user “loves” or “hearts” the current content of the presentation, such as what the presenter 314 is saying or what visual content is being currently being presented as part of virtual presentation 304a. Selectable option 318b corresponds to a “laugher” reaction, which when selected by the user conveys that the user “laughs” or finds the current content of the presentation amusing. Selectable option 318c corresponds to a “clapping” reaction, which when selected by the user conveys that the user “claps” or applauds the content of the presentation. Selectable options 318d and 318e, respectively correspond to a “thumbs up” reaction and a “thumbs down” reaction, which when selected by the user conveys that the user “agrees” or “disagrees” (or “likes” or “dislikes”) the content of the presentation. It is understood that the illustrated reactions are representative, and the fewer, more, or different reactions may be implemented.

In one or more examples, and as illustrated in FIG. 3B, user 308 selects selectable option 318d which corresponds to a “thumbs-up” reaction by directing their gaze 310 to selectable option 318d and performing an air gesture, such as an air pinch, with their hand 312 (or by tapping selectable option 318d with a finger). In one or more examples, and in response to receiving input corresponding to a reaction from user 308 or from other audience members that are also attending the virtual presentation 304a, electronic device 101 can display one or more visual indicators on or near audience reaction user interface 316 indicating the users reaction or aggregate audience reactions at a given time during the virtual presentation as illustrated in FIG. 3D.

In the example of FIG. 3D, visual indicators 330a-330c are displayed by electronic device 101 in accordance with an aggregate audience reaction determination. For instance, visual indicator 330a indicates an aggregation of the “heart” reaction to the virtual presentation from the audience members of virtual presentation 304a. In some examples, visual indicator 330a can take the form of a wave shape whose height is proportional to the number of audience members that have also applied the “heart” reaction to virtual presentation 304a. Similarly, visual indicator 330b corresponds to the “clapping” reaction, while visual indicator 330c corresponds to the “thumbs up” reaction. As illustrated in FIG. 3D, the height of the wave of visual indicator 330c (e.g., the thumbs up reaction) is bigger than visual indicators 330a and 330b, thus indicating that more audience members have indicated a thumbs up reaction than the other pre-defined reactions. In some examples, the theater presentation application running on electronic device 101 can receive a count of how many audience members have applied a particular pre-defined reaction to the virtual presentation 304a and cause the visual indicators to be displayed based on the received count. In some examples, electronic device 101 can play synthetic audio based on aggregate reactions recorded. For instance, if audience members are applying “clapping” reactions to the presentation, then electronic device 101 can generate synthetic clapping sounds that can be heard by user 308. In some examples, the volume of the synthetic reaction sound can be proportional to the number of audience members that have applied a reaction to the virtual presentation. In some examples, and in response to receiving input from user 308, the one or more audience reactions 318a-318e can have their appearance modified (e.g., made visually distinct) to indicate that the user has selected the reaction. In some examples, the visual indicators described above can be applied once the aggregate number of a particular reaction exceeds a minimum pre-define threshold. In one or more examples, the visual indicators can be displayed for a pre-defined amount of time and once the pre-define amount of time has been exceeded, the visual indicators can be updated by electronic device 101 to reflect the current aggregate reactions to virtual presentation 304a.

In some examples, and as discussed above, reactions can be selected from the audience reaction user interface 316. Additionally or alternatively, electronic device 101 can register a reaction by detecting that the user's hand is engaged in a pre-defined air gesture as illustrated in FIG. 3E. In the example of FIG. 3E, rather than interacting with audience reaction user interface 316, the user 308 can instead register a reaction using one or more pre-defined hand gestures that can be recognized by electronic device 101 as pertaining to one of the pre-defined reactions included as part of audience reaction user interface 316. For instance, as illustrated in FIG. 3E, user 308, using their hand 312 can make a thumbs-up hand gesture. In some examples, electronic device 101 using one or more of the cameras 114a-114c, can detect the thumbs-up gesture made by hand 312 and correlate it to the pre-defined thumbs-up reaction corresponding to selectable option 318d of audience reaction user interface 316. In one or more examples, electronic device 101 can treat the thumbs-up gesture made by hand 312 in the same manner as if user 308 had selected selectable option 318d as described above. The thumbs-up gesture described above is used for illustration purposes only and should not be seen as limiting. The examples described above could also be applied to other reactions such as the “heart” reaction, the thumbs-down reaction, etc. In some examples, a selected reaction can be made visually distinct from non-selected reactions, for instance by surfacing (e.g., using interface 316) the reaction.

In one or more example of the disclosure, the virtual presentation 304a can include displaying a virtual object that the user can interact with and manipulate as shown in FIG. 3F. In the example of FIG. 3F, the virtual presentation 304a includes a three-dimensional virtual object 332 (in this example a three-dimensional octopus) that is displayed by electronic device 101 as part of virtual presentation 304a. In one or more examples, presenter 314 can initiate the display of virtual object 332 while delivering the presentation. In one or more examples, each individual audience member views their own independent copy of virtual object 332 on their own individual electronic device. In some examples, virtual object 332 is placed within the three-dimensional environment such that it does not obstruct the user's 308 view of the presenter 314. As discussed in further detail below, each audience member can interact with and manipulate virtual object 332 independent from one another. For instance, an audience member 322b may not be able to see the manner in which user 308 is interacting with and manipulating virtual object 332 on electronic device 101, however audience member 322b is able to independently interact with virtual object 332 on their own electronic device.

In some examples, the virtual object 332 can include one or more virtual object user interface elements 334a-334c that when selected by the user, causes electronic device 101 to display additional information pertaining to virtual object 322. For instance, in response to detecting the user's gaze 310 directed at virtual object user interface element 334a while the user performs an air pinch with their hand 312, an information user interface is displayed by electronic device 101 as illustrated in FIG. 3G.

In the example of FIG. 3G, in response to selection of virtual object user interface 334a, electronic device 101 displays information interface 336 that displays information pertaining to virtual object 332. In one or more examples, the user can close information interface 336 by “re-selecting” virtual object user interface element 334a (e.g., by performing an air pinch with hand 312 while directing gaze 310 at virtual object user interface element 334a). Additionally, element 334a can be closed in response to the user opening element 334b-334c. In one or more examples, virtual object 332 can be manipulated by user 308 as illustrated in FIG. 3H. In one or more examples, electronic device 101 facilitates changing the orientation at which virtual object 332 is displayed via user interaction with the three-dimensional representation. For instance, in response to a user input (e.g., an air pinch gesture while the attention of the user (e.g., gaze 310) is directed to the virtual object 332, and movement of the user's hand 312 (while engaged in the air pinch), the electronic device changes the orientation of virtual object 332 as illustrated in FIG. 3H. As illustrated in FIG. 3H, the orientation of three-dimensional representation 332 has been modified by the electronic device 101 commensurate with the movement of the user's hand 312. For instance, as illustrated in FIG. 3H, virtual object 332 is now shown from a bottom perspective.

In one or more examples, virtual presentation 304a can include a virtual survey as illustrated in FIG. 31. In the example of FIG. 31, presenter 314 has initiated a virtual survey in virtual presentation 304a. In some examples, a virtual survey refers to a question that optionally includes one or more pre-defined answers that an audience member can select. In some examples, the theater application that is implementing virtual presentation 304a can record responses to the survey from each of the audience members and display a visual indicator to show the aggregate responses to the survey optionally when requested by the presenter 314.

In one or more examples, as part of implementing a virtual survey, electronic device 101 displays two separate user interfaces: A question user interface 338 and an answer user interface 340. Each of question user interface 338 and answer user interface 340 can be considered parts of the same audience survey user interface (or different corresponding user interfaces). In one or more examples, the audience survey user interface can provide the user with one or more selectable options that are set by the presenter 314 of virtual presentation 304a. In one or more examples, question user interface 338 displays the question the survey seeks an answer to. Additionally, in some examples, and as illustrated in FIG. 31, question user interface 338 can also include one or more visual indicators 344 that show the current aggregate responses to the survey question (e.g., a running count of how many people in the audience have answered the question with a particular answer.) In one or more examples, the virtual survey includes an answer user interface 340 that is configured to record the answer provided by user 308 to the survey question. In some examples, answer user interface can provide a visual representation of the answer options to the survey question. In one or more examples, the user 308 can select an answer by performing an air pinch with hand 312 while directing their gaze 310 at the answer they wish to select (or by tapping the answer in the user interface with a finger or by audio command). In some examples, in response to receiving a selection of an answer from user 308, electronic device 101 can display visual indicator 342 to provide a visual indication of which answer user 308 selected as shown in FIG. 31. In one or more examples, and as illustrated in FIG. 31, presenter 314 can be repositioned within the virtual presentation 304a such that the presenter does not obstruct the user's view of the virtual survey.

In one or more examples, audience members (including user 308 of electronic device 101) can be promoted to become a presenter along with presenter 314 as shown in FIG. 3J. For instance, returning to the example of FIG. 3C, audience member 324 can be selected by presenter 314 for promotion to a presenter role. Thus, as illustrated in the example of FIG. 3J, once presenter 314 has selected audience member 324 to be a presenter, virtual presentation 304a is displayed to audience member 324 from a presenter viewpoint (not shown) rather than the audience viewpoint. In one or more examples, the audience viewpoint seen by user 308 shows promoted audience member 324 placed on virtual stage 320 with the audience member 324 facing the audience. In one or more examples, the presenter viewpoint for promoted audience member 324 is from the perspective of promoted audience member 324 placed on virtual stage 320 with the audience member 324 facing the audience. In one or more examples, when in presenter viewpoint, audience member 324 may also have one or more control interfaces that allow them efficiently present. For instance, audience member may have one or more notes or can control crowd noise, etc., while in the presenter viewpoint. In one or more examples, the presenter viewpoint can be the same viewpoint that the user associated with presenter 314 views while engaging with the virtual presentation. Additionally or alternatively, since audience member 324 is an invited presenter and not the main presenter, the presenter viewpoint they experience may include a subset of the features available to presenter 314. In one or more examples, in addition to transition from an audience member to a presenter as discussed above with respect to FIG. 3J, an audience member can be selected to be a questioner by a presenter of virtual presentation 304a as illustrated in FIG. 3K. Additionally or alternatively, the user can be promoted to questioner automatically in response to “raising their hand” as described above. In the example of FIG. 3K, one of the audience members of audience members 322a have been promoted by the presenter to be a questioner. In some examples, the presenter 314 can promote an audience member to be a questioner in response to receiving an indication that an audience member has a question for instance because the audience member has selected selectable option 346 of the question user interface as described above. In some examples, the user can also indicate that they have a question by raising their hand (which is detected by the electronic device). As illustrated in FIG. 3K, when an audience member such as audience member 352 is promoted from being an audience member 322a to a questioner, their appearance within the three-dimensional environment can be rendered distinct from other audience members by displaying a microphone 350a or some other visual indicator (e.g., a lectern or stand) that illustrates that the audience member 352 has been promoted to a questioner role. In some examples, the position of the audience member who is promoted to a questioner role can be modified such that it is closer to both the user 308 as well as stage 320. In one or more examples, whether via a hand raising gesture or selection of selectable option 346, the electronic device optionally provides a visual indication that the input has been accepted (e.g., changing the appearance of selectable option 346). In one or more examples, the visual indication ceases to be displayed after a threshold period of time, after a cancelation input (e.g., putting hand down, again selecting selectable option 346, etc.), and/or after the user is promoted to questioner.

In one or more examples, and in addition to presenting a virtual object to the audience members as part of the presentation as discussed above with respect to FIGS. 3F-3H, the presenter 314 of the virtual presentation can also transmit a virtual object to one or more audience members of the virtual presentation as illustrated in FIG. 3L. In the example of FIG. 3L, presenter 314 of virtual presentation 304a has transmitted a virtual object 354 to the user 308 of the electronic device 101. In one or more examples, and in response to receiving virtual object 354 from the virtual presentation, electronic device 101 displays a virtual object download user interface 356 configured to receive input from the user of the electronic device as to whether they wish to accept the virtual object and download the virtual object 354 to the memory of the electronic device 101 or decline the virtual object 354 thereby forgoing downloading of the virtual object. In some examples, virtual object download user interface 356 can include textual information identifying the identity of the individual sharing virtual object 354, as well information regarding the contents of virtual object 354.

In one or more examples, the theater application can present a virtual presentation to a presenter from the presenter viewpoint as illustrated in FIG. 3M. In one or more examples, electronic device 101 displays the virtual presentation in the presenter viewpoint upon detecting that the user associated with electronic device is a presenter of the virtual presentation and/or upon detecting that user of the electronic device has been promoted to a presenter (as discussed above) by another presenter of the virtual presentation. In one or more examples, the presenter viewpoint includes displaying the three-dimensional environment 302 from the perspective of a presenter on the stage of the virtual presentation (described above) looking out towards the audience. Thus, in one or more examples, while in the presentation viewpoint, the device displays the audience members at varying levels of detail. For instance, in one or more examples, the audience members that are closest to the user's perspective can be displayed according to the high-fidelity level of detail described above. In some examples, audience members who are farther away can be displayed according to the medium-fidelity level of detail described above. In some examples, the audience members who are furthest away can be displayed according to the low-fidelity level of detail described above. In one or more examples, the high-fidelity, medium-fidelity, and low-fidelity levels of detail share one or more characteristics with the levels of detail described with respect to FIG. 3C. In one or more examples, the placement of audience members can be based one or more factors including but not limited to: the order in which the audience members joined the virtual presentation (e.g., the first users to join are placed in the front of the audience, whether the audience member is known to the presenter (e.g., within their personal contacts, or in a communication session with the presenter), and/or any criteria that differentiates one or more audience members from one another.

In one or more examples, the presenter viewpoint can include a presenter controls user interface 356 for controlling one or more aspects of the virtual presentation. For instance, presenter controls user interface 356 can include one or more visual aids 362 that are configured present a visual representation of what a user in the audience viewpoint is seeing (e.g., virtual objects and other portions of the presentation). In some examples, presenter controls user interface 356 also includes one or more selectable options for configuring parameters associated with the virtual presentation. For instance, selection of the one or more selectable options 358 allows the user to adjust the volume of audience noise in the presentation, adjust brightness, color or other visual settings, and/or adjust any parameters associated with virtual presentation.

In one or more examples, the presenter viewpoint includes a presenter reaction user interface 360 for receiving reactions from the presenter and for displaying aggregate reactions from audience members. In one or more examples, presenter reaction user interface 360 shares one or more characteristics with audience reaction user interface 316 described above, including but not limited the visual indicators described above for indicating aggregate audience member reactions to the virtual presentation.

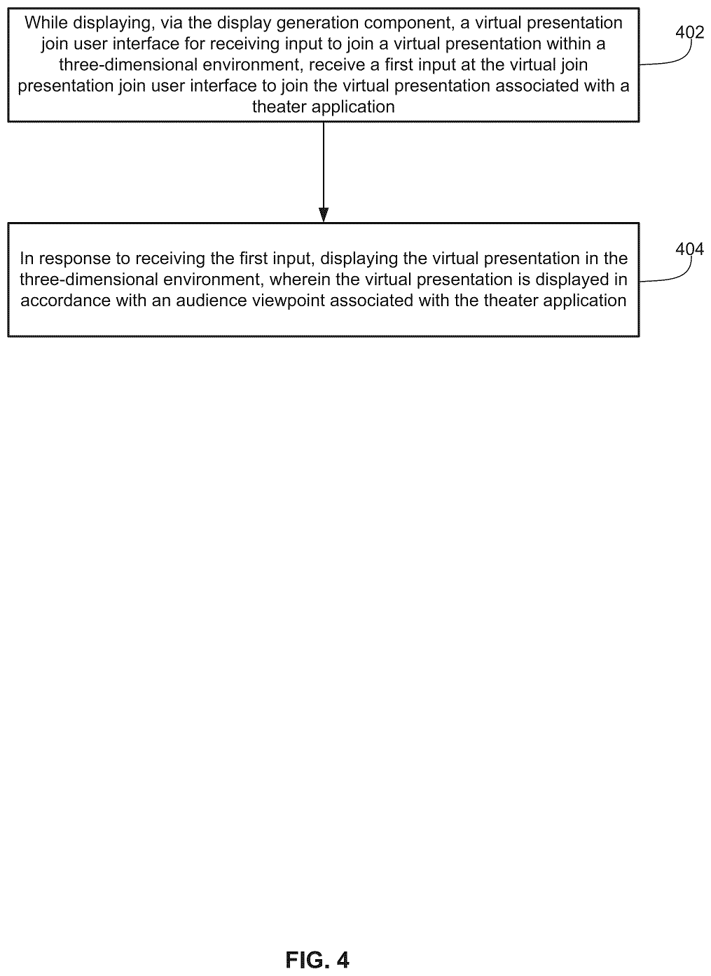

FIG. 4 illustrates an example flow diagram illustrating a method of displaying virtual presentations associated with a theater application according to examples of the disclosure. In some examples, while displaying, via the display generation component, a virtual presentation launch user interface (e.g., such launch user interface 306) for receiving input to join a virtual presentation within a three-dimensional environment, electronic device 101 receives (402) a first input at the virtual presentation launch user interface to join the virtual presentation associated with a theater application. In some examples, the theater application facilitates interactions between a presenter of a virtual presentation and one or more audience members of the virtual presentation. In some examples, a user of electronic device 101 can access a plurality of virtual presentations through the theater application, and can select one of the plurality of virtual presentation to view at any given time. In some examples, upon selecting a virtual presentation to view, the user of electronic device 101 is presented with a virtual presentation launch user interface, which when selected will allow the user to participate in the virtual presentation as an audience member (as described above, and in further detail below).

In one or more examples, and in response to receiving the first input, electronic device 101 displays (404) the virtual presentation in the three-dimensional environment and in accordance with an audience viewpoint associated with the theater application. In one or more examples, the virtual presentation is displayed in the three-dimensional environment in front of the user and is overlaid over the background of the three-dimensional environment. For instance, if the three-dimensional environment is a mixed-reality environment in which the three-dimensional environment includes at least a portion of the physical real-world environment surrounding electronic device 101, then the virtual presentation is overlaid on top the mixed reality environment such that the user of the device is able to see at least a portion of their physical real-world environment while viewing the virtual presentation. In one or more examples, and in accordance with displaying the virtual presentation in the audience viewpoint, electronic device 101 displays the virtual presentation in front of and to the center of the perspective of the user. Thus, when viewing the virtual presentation, the user sees the virtual presentation and the other audience members from the perspective of an audience member that is sitting in the front row and in the center of an auditorium of the presentation.

It is understood that process 400 is an example and that more, fewer, or different operations can be performed in the same or in a different order. Additionally, the operations in process 400 described above are, optionally, implemented by running one or more functional modules in an information processing apparatus such as general-purpose processors (e.g., as described with respect to FIG. 2) or application specific chips, and/or by other components of FIG. 2.

Therefore, according to the above, some examples of the disclosure are directed to a method comprising: at an electronic device in communication with one or more displays and one or more input devices: while displaying, via the display generation component, a virtual presentation launch user interface for receiving input to join a virtual presentation associated with a theater application within a three-dimensional environment, receiving a first input at the virtual presentation launch user interface to join the virtual presentation associated with the theater application, and in response to receiving the first input, displaying the virtual presentation in the three-dimensional environment, wherein the virtual presentation is displayed in accordance with an audience viewpoint associated with the theater application.

Optionally, displaying the virtual presentation according to the audience viewpoint associated with the theater application comprises: displaying a virtual stage within the three-dimensional environment, wherein the virtual stage is displayed in front of a perspective of the user of the electronic device, and displaying a plurality of representations of audience members of the virtual presentation within the displayed three-dimensional environment, wherein one or more of the plurality of representations of the audience members correspond to one or more participants of the virtual presentation, and wherein the plurality of representations of the audience members are placed within the three-dimensional environment to one or more sides of the perspective of the user of the electronic device.

Optionally, a first representation of the plurality of representations of the audience members corresponds to a first participant of the virtual presentation, wherein the user of the electronic device was engaged in a communication session with the first participant prior to the first input, wherein a second representation of the plurality of representations of the audience members corresponds to a second participant of the virtual presentation, wherein the user of the electronic device was not engaged in the communication session with the second participant prior to the first input, and wherein the first representation is displayed with a greater visual prominence than the second representation.

Optionally, a visual prominence of the one or more representations of the plurality of representations is based on a proximity of the one or more representations to a location of the user of the electronic device within the three-dimensional environment.

Optionally, the method further comprises: while displaying the virtual presentation according to the audience viewpoint associated with the theater application, presenting synthetic audience audio, wherein the synthetic audience audio is based on a real-world audience sound.

Optionally, the method further comprises: while displaying the virtual presentation according to the audience viewpoint associated with the theater application, displaying an audience reaction user interface for selecting one or more reactions associated with the theater application.

Optionally, the method further comprises: while displaying the audience reaction user interface, receiving, via the one or more input devices, a first input corresponding to a selection of a reaction of the one or more reactions associated with the theater application, and in response to receiving the first input, applying the selected reaction to the virtual presentation.

Optionally, the audience reaction user interface includes one or more visual indicators, each visual indicator corresponding to one of the one or more reactions associated with the theater application, and wherein each visual indicator of the one or more visual indicators is configured to indicate an aggregated audience reaction for one of the one or more reactions to the virtual presentation.

Optionally, the method further comprises presenting audience reaction audio, wherein the audience reaction audio is based on the aggregated audience reaction to the virtual presentation.

Optionally, the method further comprises: receiving a second input, wherein the second input includes input from a first portion of the user, determining that the second input corresponds to a reaction of one or more reactions associated with the theater application, and in response to determining that the second input corresponds to the reaction of the one or more reactions associated with the theater application, applying the reaction corresponding to the second input to the virtual presentation.

Optionally, the method further comprises: while displaying the virtual presentation, displaying a three-dimensional virtual object associated with the virtual presentation at a location within the three-dimensional environment that is in front of a perspective of the user perspective.

Optionally, the method further comprises: while displaying the virtual presentation including the three-dimensional virtual object, receiving a third input from a second portion of the user, including a first air gesture directed to the three-dimensional virtual object followed by movement of the second portion of the user, and in response to receiving the third input, rotating the three-dimensional virtual object relative to the three-dimensional environment in accordance with the detected movement of the second portion of the user.

Optionally, the method further comprises: while displaying the virtual presentation according to the audience viewpoint associated with the theater application, displaying an audience survey user interface for selecting one or more answers associated with a survey question that is displayed as part of the virtual presentation, while displaying the audience survey user interface, receiving, via the one or more input devices, a first input corresponding to a selection of an answer of the one or more answers associated with the survey question, and in response to receiving the first input, transmitting an indication of the selected answer to the theater application.

Optionally, the method further comprises: while displaying the virtual presentation according to the audience viewpoint associated with the theater application, receiving an indication to display the virtual presentation in accordance with a presenter viewpoint associated with the theater application, and in response to receiving the indication to display the virtual presentation in accordance with the presenter viewpoint, ceasing display of the virtual presentation in accordance with the audience viewpoint and displaying the virtual presentation in accordance with the presenter viewpoint.

Optionally, the method further comprises: while displaying the virtual presentation according to the audience viewpoint associated with the theater application, receiving an indication to display the virtual presentation in accordance with a questioner viewpoint associated with the theater application, and in response to receiving the indication to display the virtual presentation in accordance with the questioner viewpoint, ceasing display of the virtual presentation in accordance with the audience viewpoint and displaying the virtual presentation in accordance with the questioner viewpoint.

Optionally, the method further comprises: while displaying the virtual presentation according to the audience viewpoint associated with the theater application, receiving a virtual object from the theater application, in response to receiving the virtual object from the theater application, displaying a virtual object download user interface for downloading the virtual object to a memory of the electronic device, while displaying the virtual object download user interface, receiving, via the one or more input devices, a first input corresponding to a request to download the received virtual object to the memory of the electronic device, and in response to receiving the first input, storing the received virtual object to the memory of the electronic device.

Optionally, the displayed three-dimensional environment includes one or more virtual elements that are based on a real-world environment in of the computers system.

Some examples of the disclosure are directed to an electronic device, comprising: one or more processors; memory; and one or more programs stored in the memory and configured to be executed by the one or more processors, the one or more programs including instructions for performing any of the above methods.

Some examples of the disclosure are directed to a non-transitory computer readable storage medium storing one or more programs, the one or more programs comprising instructions, which when executed by one or more processors of an electronic device, cause the electronic device to perform any of the above methods.

Some examples of the disclosure are directed to an electronic device, comprising one or more processors, memory, and means for performing any of the above methods.

Some examples of the disclosure are directed to an information processing apparatus for use in an electronic device, the information processing apparatus comprising means for performing any of the above methods.

The foregoing description, for purpose of explanation, has been described with reference to specific examples. However, the illustrative discussions above are not intended to be exhaustive or to limit the disclosure to the precise forms disclosed. Many modifications and variations are possible in view of the above teachings. The examples were chosen and described in order to best explain the principles of the disclosure and its practical applications, to thereby enable others skilled in the art to best use the disclosure and various described examples with various modifications as are suited to the particular use contemplated.

What is claimed is:

1. A method comprising:
at an electronic device in communication with one or more displays and one or more input devices:
while displaying, via the one or more displays, a virtual presentation launch user interface for receiving input to join a virtual presentation associated with a theater application within a three-dimensional environment, receiving a first input at the virtual presentation launch user interface to join the virtual presentation associated with the theater application; and
in response to receiving the first input, displaying the virtual presentation in the three-dimensional environment, wherein the virtual presentation is displayed in accordance with an audience viewpoint associated with the theater application.

2. The method of claim 1, wherein displaying the virtual presentation according to the audience viewpoint associated with the theater application comprises:
displaying a virtual stage within the three-dimensional environment, wherein the virtual stage is displayed in front of a perspective of a user of the electronic device; and
displaying a plurality of representations of audience members of the virtual presentation within the three-dimensional environment, wherein one or more of the plurality of representations of the audience members correspond to one or more participants of the virtual presentation, and wherein the plurality of representations of the audience members are placed within the three-dimensional environment to one or more sides of the perspective of the user of the electronic device.

3. The method of claim 2, wherein a first representation of the plurality of representations of the audience members corresponds to a first participant of the virtual presentation, wherein the user of the electronic device was engaged in a communication session with the first participant prior to the first input, wherein a second representation of the plurality of representations of the audience members corresponds to a second participant of the virtual presentation, wherein the user of the electronic device was not engaged in the communication session with the second participant prior to the first input, and wherein the first representation is displayed with a greater visual prominence than the second representation.

4. The method of claim 1, wherein the method further comprises:
while displaying the virtual presentation according to the audience viewpoint associated with the theater application, displaying an audience reaction user interface for selecting one or more reactions associated with the theater application.

5. The method of claim 4, wherein the audience reaction user interface includes one or more visual indicators, each visual indicator corresponding to one of the one or more reactions associated with the theater application, and wherein each visual indicator of the one or more visual indicators is configured to indicate an aggregated audience reaction for one of the one or more reactions to the virtual presentation.

6. The method of claim 1, wherein the method further comprises:
receiving a second input, wherein the second input includes input from a first portion of the user;
determining that the second input corresponds to a reaction of one or more reactions associated with the theater application; and
in response to determining that the second input corresponds to the reaction of the one or more reactions associated with the theater application, applying the reaction corresponding to the second input to the virtual presentation.

7. The method of claim 1, wherein the method further comprises:
while displaying the virtual presentation according to the audience viewpoint associated with the theater application, receiving an indication to display the virtual presentation in accordance with a presenter viewpoint associated with the theater application; and
in response to receiving the indication to display the virtual presentation in accordance with the presenter viewpoint, ceasing display of the virtual presentation in accordance with the audience viewpoint and displaying the virtual presentation in accordance with the presenter viewpoint.

8. The method of claim 1, wherein the method further comprises:
while displaying the virtual presentation according to the audience viewpoint associated with the theater application, receiving an indication to display the virtual presentation in accordance with a questioner viewpoint associated with the theater application; and
in response to receiving the indication to display the virtual presentation in accordance with the questioner viewpoint, ceasing display of the virtual presentation in accordance with the audience viewpoint and displaying the virtual presentation in accordance with the questioner viewpoint.

9. An electronic device that is in communication with one or more displays and one or more input devices, the electronic device comprising:
one or more processors;
memory; and
one or more programs, wherein the one or more programs are stored in the memory and configured to be executed by the one or more processors, the one or more programs including instructions for:
while displaying, via the one or more displays, a virtual presentation launch user interface for receiving input to join a virtual presentation associated with a theater application within a three-dimensional environment, receiving a first input at the virtual presentation launch user interface to join the virtual presentation associated with the theater application; and
in response to receiving the first input, displaying the virtual presentation in the three-dimensional environment, wherein the virtual presentation is displayed in accordance with an audience viewpoint associated with the theater application.

10. The electronic device of claim 9, wherein displaying the virtual presentation according to the audience viewpoint associated with the theater application comprises:
displaying a virtual stage within the three-dimensional environment, wherein the virtual stage is displayed in front of a perspective of a user of the electronic device; and
displaying a plurality of representations of audience members of the virtual presentation within the three-dimensional environment, wherein one or more of the plurality of representations of the audience members correspond to one or more participants of the virtual presentation, and wherein the plurality of representations of the audience members are placed within the three-dimensional environment to one or more sides of the perspective of the user of the electronic device.

11. The electronic device of claim 10, wherein a first representation of the plurality of representations of the audience members corresponds to a first participant of the virtual presentation, wherein the user of the electronic device was engaged in a communication session with the first participant prior to the first input, wherein a second representation of the plurality of representations of the audience members corresponds to a second participant of the virtual presentation, wherein the user of the electronic device was not engaged in the communication session with the second participant prior to the first input, and wherein the first representation is displayed with a greater visual prominence than the second representation.

12. The electronic device of claim 9, wherein the one or more programs include further instructions for:
while displaying the virtual presentation according to the audience viewpoint associated with the theater application, displaying an audience reaction user interface for selecting one or more reactions associated with the theater application.

13. The electronic device of claim 12, wherein the audience reaction user interface includes one or more visual indicators, each visual indicator corresponding to one of the one or more reactions associated with the theater application, and wherein each visual indicator of the one or more visual indicators is configured to indicate an aggregated audience reaction for one of the one or more reactions to the virtual presentation.

14. The electronic device of claim 9, wherein the one or more programs include further instructions for:
receiving a second input, wherein the second input includes input from a first portion of the user;
determining that the second input corresponds to a reaction of one or more reactions associated with the theater application; and
in response to determining that the second input corresponds to the reaction of the one or more reactions associated with the theater application, applying the reaction corresponding to the second input to the virtual presentation.

15. The electronic device of claim 9, wherein the one or more programs include further instructions for:
while displaying the virtual presentation according to the audience viewpoint associated with the theater application, receiving an indication to display the virtual presentation in accordance with a presenter viewpoint associated with the theater application; and
in response to receiving the indication to display the virtual presentation in accordance with the presenter viewpoint, ceasing display of the virtual presentation in accordance with the audience viewpoint and displaying the virtual presentation in accordance with the presenter viewpoint.

16. The electronic device of claim 9, wherein the one or more programs include further instructions for:
while displaying the virtual presentation according to the audience viewpoint associated with the theater application, receiving an indication to display the virtual presentation in accordance with a questioner viewpoint associated with the theater application; and
in response to receiving the indication to display the virtual presentation in accordance with the questioner viewpoint, ceasing display of the virtual presentation in accordance with the audience viewpoint and displaying the virtual presentation in accordance with the questioner viewpoint.

17. A non-transitory computer readable storage medium storing one or more programs, the one or more programs comprising instructions, which when executed by one or more processors of an electronic device, cause the electronic device to:
while displaying, via one or more displays, a virtual presentation launch user interface for receiving input to join a virtual presentation associated with a theater application within a three-dimensional environment, receive a first input at the virtual presentation launch user interface to join the virtual presentation associated with the theater application; and
in response to receiving the first input, display the virtual presentation in the three-dimensional environment, wherein the virtual presentation is displayed in accordance with an audience viewpoint associated with the theater application.

18. The non-transitory computer readable storage medium of claim 17, wherein displaying the virtual presentation according to the audience viewpoint associated with the theater application comprises:
displaying a virtual stage within the three-dimensional environment, wherein the virtual stage is displayed in front of a perspective of a user of the electronic device; and
displaying a plurality of representations of audience members of the virtual presentation within the three-dimensional environment, wherein one or more of the plurality of representations of the audience members correspond to one or more participants of the virtual presentation, and wherein the plurality of representations of the audience members are placed within the three-dimensional environment to one or more sides of the perspective of the user of the electronic device.

19. The non-transitory computer readable storage medium of claim 18, wherein a first representation of the plurality of representations of the audience members corresponds to a first participant of the virtual presentation, wherein the user of the electronic device was engaged in a communication session with the first participant prior to the first input, wherein a second representation of the plurality of representations of the audience members corresponds to a second participant of the virtual presentation, wherein the user of the electronic device was not engaged in the communication session with the second participant prior to the first input, and wherein the first representation is displayed with a greater visual prominence than the second representation.

20. The non-transitory computer readable storage medium of claim 17, wherein the one or programs further cause the electronic device to:
while displaying the virtual presentation according to the audience viewpoint associated with the theater application, display an audience reaction user interface for selecting one or more reactions associated with the theater application.

21. The non-transitory computer readable storage medium of claim 20, wherein the audience reaction user interface includes one or more visual indicators, each visual indicator corresponding to one of the one or more reactions associated with the theater application, and wherein each visual indicator of the one or more visual indicators is configured to indicate an aggregated audience reaction for one of the one or more reactions to the virtual presentation.

22. The non-transitory computer readable storage medium of claim 17, wherein the one or programs further cause the electronic device to:
receive a second input, wherein the second input includes input from a first portion of the user;
determine that the second input corresponds to a reaction of one or more reactions associated with the theater application; and
in response to determining that the second input corresponds to the reaction of the one or more reactions associated with the theater application, apply the reaction corresponding to the second input to the virtual presentation.

23. The non-transitory computer readable storage medium of claim 17, wherein the one or programs further cause the electronic device to:
while displaying the virtual presentation according to the audience viewpoint associated with the theater application, receive an indication to display the virtual presentation in accordance with a presenter viewpoint associated with the theater application; and
in response to receiving the indication to display the virtual presentation in accordance with the presenter viewpoint, cease display of the virtual presentation in accordance with the audience viewpoint and displaying the virtual presentation in accordance with the presenter viewpoint.

24. The non-transitory computer readable storage medium of claim 17, wherein the one or programs further cause the electronic device to:
while displaying the virtual presentation according to the audience viewpoint associated with the theater application, receive an indication to display the virtual presentation in accordance with a questioner viewpoint associated with the theater application; and
in response to receiving the indication to display the virtual presentation in accordance with the questioner viewpoint, cease display of the virtual presentation in accordance with the audience viewpoint and displaying the virtual presentation in accordance with the questioner viewpoint.
